(19) United States
(12) Patent Application Publication
(10) Pub. No.: US 2013/0278097 A1
(43) Pub. Date: Oct. 24, 2013

(54) MOTOR

(71) Applicant: NIDEC SANKYO CORPORATION, Nagano (JP)

(72) Inventor: Nobuaki TANAKA, Nagano (JP)

(73) Assignee: NIDEC SANKYO CORPORATION, Nagano (JP)

(21) Appl. No.: 13/864,861

(22) Filed: Apr. 17, 2013

(30) Foreign Application Priority Data
Apr. 18, 2012 (JP) 2012-94514

(51) Int. Cl. H02K 7/08; H02K 7/06

(52) U.S. Cl. CPC H02K 7/081; H02K 7/06
USPC 310/80; 310/90

(57) ABSTRACT

A motor may include a rotation shaft whose output side includes a feed screw, a permanent magnet fixed to an outer peripheral face on an opposite-to-output side of the rotation shaft, a stator having a drive coil disposed on an outer peripheral side with respect to the permanent magnet, a bearing which supports an end part on the opposite-to-output side of the rotation shaft, a bearing holder which is fixed to the stator and slidably holds the bearing in the axial direction, and an urging member which urges the bearing to an output side. The bearing may be formed with a protruded part which is protruded to an outer side in a radial direction of the rotation shaft, and the protruded part may be disposed between an end face on the opposite-to-output side of the permanent magnet and an end face on the output side of the bearing holder.

### CROSS REFERENCE TO RELATED APPLICATION

The present invention claims priority under 35 U.S.C. §119 to Japanese Application No. 2012-094514 filed Apr. 18, 2012, the entire content of which is incorporated herein by reference.

### FIELD OF THE INVENTION

At least an embodiment of the present invention may relate to a motor having a rotation shaft whose output side is fixed or formed with a feed screw.

### BACKGROUND

Conventionally, as shown in FIGS. 4(A) and 4(B), a stepping motor 100 has been known which includes a rotor 103 having a rotation shaft 101 and a permanent magnet 102 fixed to the rotation shaft 101, and a stator 106 having pole teeth 104 which face an outer peripheral face of the permanent magnet 102 and a drive coil 105 which is disposed on an outer peripheral side of the pole teeth 104 (see, for example, Japanese Patent Laid-Open No. Hei 9-154271). In the stepping motor 100, an output side of the rotation shaft 101 is protruded from the stator 106 and a feed screw is formed on an output side of the rotation shaft 101. A fed body not shown is engaged with the feed screw. The fed body is linearly moved along the feed screw when the rotation shaft 101 is rotated. The fed body is, for example, a nut which is formed on its inner peripheral side with a female screw engaged with the feed screw, a rack which is formed on its inner peripheral side with a pawl part engaged with the feed screw, or the like.

Further, in the stepping motor 100, an end part on an opposite-to-output side of the rotation shaft 101 is rotatably supported by a bearing 109 comprised of a ball 107 and a ball holding body 108. A guide member 110 which holds the ball holding body 108 is fixed to an end face on the opposite-to-output side of the stator 106 and the ball holding body 108 is capable of sliding in an axial direction with respect to the guide member 110. Further, the ball holding body 108 is urged to an output side by a plate spring 111 which is attached to the guide member 110. An end part on the output side of the rotation shaft 101 is rotatably supported by a bearing not shown which is comprised of a ball and a ball holding body. The ball holding body disposed on the output side of the rotation shaft 101 is fixed to a frame.

In the stepping motor 100, a gap space is normally formed between an end face 102a on the opposite-to-output side of the permanent magnet 102 and an end face 110a on the output side of the guide member 110 so that the rotor 103 is capable of being smoothly rotated (see FIG. 4(A)). However, in a case that the rotation shaft 101 is rotated at a predetermined speed so that the fed body engaged with the feed screw is moved to the output side of the rotation shaft 101, when the fed body is collided with the ball holding body disposed on the output side of the rotation shaft 101 due to occurrence of a control error in the stepping motor 100, as shown in FIG. 4(B), the end face 110a of the guide member 110 is abutted with the end face 102a of the permanent magnet 102 and, as a result, sticking of the permanent magnet 102 to the guide member 110 may occur.

In other words, in a case that the rotation shaft 101 is rotated at a predetermined speed, when the fed body is collided with the ball holding body disposed on the output side of the rotation shaft 101 and then the rotation shaft 101 is further rotated in a state that the fed body is abutted with the ball holding body, a stress to the opposite-to-output side may occur in the rotor 103. Therefore, as shown in FIG. 4(B), the ball holding body 108 is moved to the opposite-to-output side together with the rotor 103 and the end face 102a of the permanent magnet 102 and the end face 110a of the guide member 110 are abutted with each other. As a result, contact friction occurred between the end face 102a of the permanent magnet 102 and the end face 110a of the guide member 110 may cause to restrict the rotation of the rotor 3. Therefore, after that, even when the rotation shaft 101 is directed to be rotated so that the fed body is moved to the opposite-to-output side, a problem may occur that the rotation shaft 101 is not rotated.

### SUMMARY

In view of the problem described above, at least an embodiment of the present invention may advantageously provide a motor provided with a rotation shaft whose output side is fixed or formed with a feed screw and, in which sticking of the bearing holder, which slidably holds a bearing that supports an end part on the opposite-to-output side of the rotation shaft, to the permanent magnet which is fixed to the rotation shaft is prevented.

According to at least an embodiment of the present invention, there may be provided a motor including a rotation shaft whose output side is formed or fixed with a feed screw, a permanent magnet which is fixed to an outer peripheral face on an opposite-to-output side of the rotation shaft, a stator having a drive coil which is disposed on an outer peripheral side with respect to the permanent magnet, a bearing which supports an end part on the opposite-to-output side of the rotation shaft at least in an axial direction of the rotation shaft, a bearing holder which is fixed to the opposite-to-output side of the stator and slidably holds the bearing in the axial direction, and an urging member which urges the bearing to an output side. The bearing is formed with a protruded part which is protruded to an outer side in a radial direction of the rotation shaft, and the protruded part is disposed between an end face on the opposite-to-output side of the permanent magnet and an end face on the output side of the bearing holder.

In the motor in accordance with at least an embodiment of the present invention, a protruded part protruding to an outer side in the radial direction is formed in a bearing which supports an end part on the opposite-to-output side of the rotation shaft at least in the axial direction, and the protruded part is disposed between an end face on the opposite-to-output side of the permanent magnet and an end face on the output side of the bearing holder. Therefore, for example, when a fed body which is moved to the output side of the rotation shaft is collided with a bearing which supports an end part on the output side of the rotation shaft and the rotation shaft is moved to the opposite-to-output side and, when a bearing on the opposite-to-output side is excessively slid to the opposite-to-output side together with the rotation shaft, the protruded part is abutted with the end face on the output side of the bearing holder, and the rotation shaft and the permanent magnet are not further moved to the opposite-to-output side. Specifically, for example, it may be structured that a gap space is formed between the protruded part and the end face on the output side of the bearing holder in a normal operating state of the motor and, when the bearing is excessively slid to the opposite-to-output side together with the rotation shaft, the protruded part of the bearing is abutted with the end face on the output side of the bearing holder to prevent slide of the bearing to the opposite-to-output side. Accordingly, in at least an embodiment of the present invention, the end face on the opposite-to-output side of the permanent magnet is prevented from being abutted with the end face on the output side of the bearing holder and, as a result, sticking of the permanent magnet to the bearing holder is prevented.

In at least an embodiment of the present invention, the protruded part is formed in a flange shape over an entire region in a circumferential direction of the rotation shaft. According to this structure, the end face on the opposite-to-output side of the permanent magnet is effectively prevented from abutting with the end face on the output side of the bearing holder.

In at least an embodiment of the present invention, the protruded part is formed at an output side end of the bearing, and the end face on the opposite-to-output side of the permanent magnet is formed with a recessed part which is recessed toward the output side so as to surround the rotation shaft and prevent from abutting with the end face on the output side of the bearing holder. Further, in at least an embodiment of the present invention, an end face on the output side of the bearing is formed with an inclined face which is inclined to the opposite-to-output side toward an outer side in the radial direction. According to this structure, even when a distance between the end face on the opposite-to-output side of the permanent magnet and the end face on the output side of the bearing is set to be small, contacting of the permanent magnet with the bearing is prevented. As a result, the size of the motor can be reduced in the axial direction. Further, according to this structure, even in a case that the protruded part is largely protruded to the outer side in the radial direction for stabilizing an abutting state of the protruded part with the bearing holder when the protruded part is abutted with the end face on the output side of the bearing holder, contacting of the permanent magnet with the protruded part can be prevented.

In at least an embodiment of the present invention, the end face on the opposite-to-output side of the permanent magnet and the end face on the output side of the bearing are disposed so as to form substantially the same plane.

In at least an embodiment of the present invention, the bearing holder is formed with a bearing holding hole which slidably holds the bearing, the end face on the output side of the bearing holder is formed with a holder recessed part which is recessed toward the opposite-to-output side, and the holder recessed part is formed so as to surround the bearing holding hole. In this case, it may be structured that the protruded part of the bearing is capable of abutting with a bottom face of the holder recessed part. According to this structure, even when the protruded part is formed in the bearing, the bearing can be slid to the opposite-to-output side by a recessed amount of the recessed part. Therefore, even when the protruded part is formed in the bearing, a slide amount of the bearing with respect to the bearing holder can be secured.

In at least an embodiment of the present invention, the bearing is formed with a bearing recessed part into which the end part on the opposite-to-output side of the rotation shaft is inserted so as to be recessed from the end face on the output side of the bearing toward the opposite-to-output side. Specifically, the bearing is formed in a substantially bottomed cylindrical tube shape with a flange, the bearing is formed with a recessed part as a bearing recessed part which is recessed toward the opposite-to-output side from the end face on the output side of the bearing, an opposite-to-output side end of the rotation shaft is inserted into the recessed part, and the protruded part is formed so as to protrude from the end face on the output side of the bearing to the outer side in the radial direction of the rotation shaft.

In at least an embodiment of the present invention, the motor further includes an output side bearing which rotatably supports an end part on the output side of the rotation shaft and a frame which is fixed with the output side bearing and is fixed to the stator, the frame is structured of a bottom face part, a side face part on the output side which is stood up at a substantially right angle from an output side end of the bottom face part, and a side face part on the opposite-to-output side which is stood up at a substantially right angle from an opposite-to-output side end of the bottom face part, and the side face part on the opposite-to-output side is fixed to the end face on the output side of the stator and the output side bearing is fixed to the side face part on the output side.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1(A) and 1(B) are a cross-sectional view showing a motor in accordance with an embodiment of the present invention. FIG. 1(A) is a view showing a state at the time of a normal operation of the motor and FIG. 1(B) is a view showing a state when a fed body is collided with a bearing.

FIG. 2 is an enlarged view showing an “E” part in FIG. 1(A).

FIG. 3 is an enlarged view showing an “F” part in FIG. 1(B).

FIGS. 4(A) and 4(B) are a cross-sectional view showing a part of a motor in a prior art.

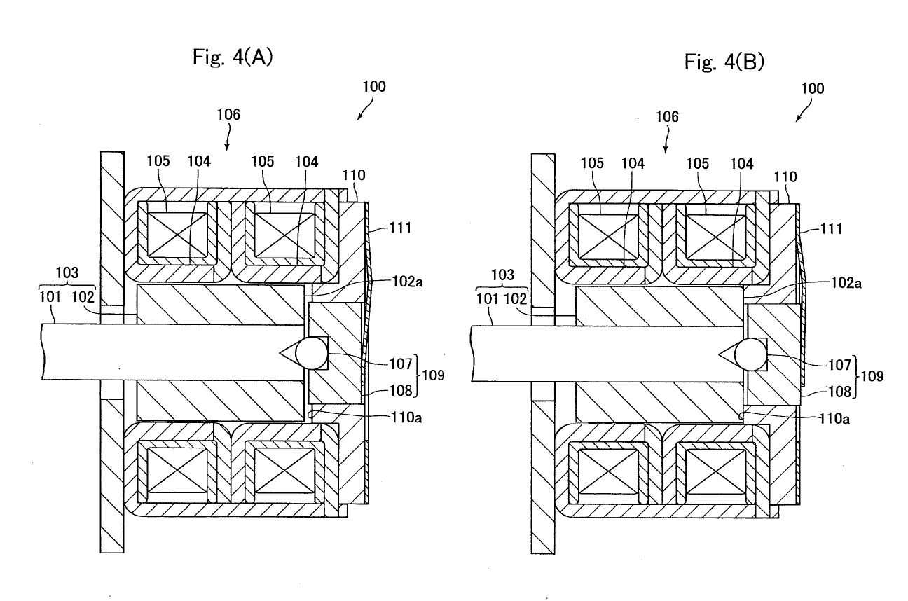

### DETAILED DESCRIPTION OF THE PREFERRED EMBODIMENTS

An embodiment of the present invention will be described below with reference to the accompanying drawings.

(Entire Structure of Motor)

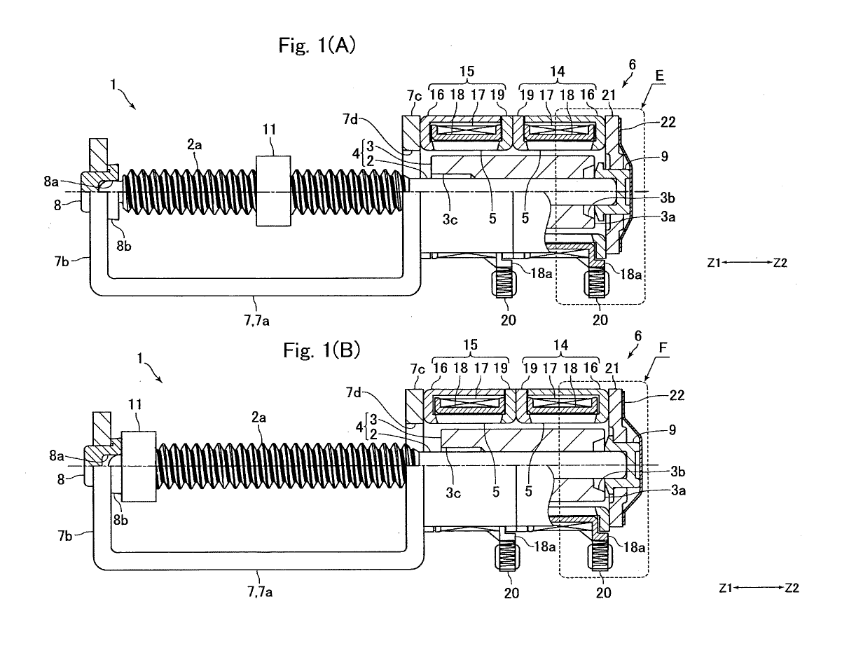

FIGS. 1(A) and 1(B) are a cross-sectional view showing a motor 1 in accordance with an embodiment of the present invention. FIG. 1(A) is a view showing a state at the time of a normal operation of the motor 1 and FIG. 1(B) is a view showing a state when a fed body 11 is collided with a bearing 8.

A motor 1 in this embodiment is a so-called PM type stepping motor. The motor 1 includes a rotor 4 having a rotation shaft 2 and a permanent magnet 3, a stator 6 having pole teeth 5 which is oppositely disposed on an outer side in a radial direction with respect to the permanent magnet 3, and a frame 7 which is fixed to the stator 6. Further, the motor 1 includes an output side bearing 8 which rotatably supports an end part on the output side of the rotation shaft 2 and an opposite-to-output side bearing 9 which rotatably supports an end part on the opposite-to-output side of the rotation shaft 2. In the following descriptions, a “Z1” direction side in FIGS. 1(A) and 1(B) and the like which is an output side of the rotation shaft 2 is referred to as an “output side” and a “Z2” direction side in FIGS. 1(A) and 1(B) and the like which is an opposite-to-output side of the rotation shaft 2 is referred to as an “opposite-to-output side”. Further, in the following descriptions, an axial direction of the rotation shaft 2 is referred to as an “axial direction”, a radial direction of the rotation shaft 2 is referred to as a “radial direction”, and a circumferential direction of the rotation shaft 2 is referred to as a “circumferential direction”.

An output side of the rotation shaft 2 is protruded to the output side from the stator 6. A feed screw (lead screw) 2a is formed on a portion of the rotation shaft 2 which is protruded from the stator 6. The feed screw 2a is engaged with a fed body 11 such as a nut whose inner peripheral face is formed with a female screw engaged with the feed screw 2a or a rack which is formed with a pawl part engaged with the feed screw 2a on its inner peripheral side. The fed body 11 is, for example, capable of being attached to a lens frame of a camera and, when the rotor 4 is rotated, the lens frame is linearly moved together with the fed body 11 along the feed screw 2a.

A permanent magnet 3 is formed in a substantially cylindrical tube shape. The permanent magnet 3 is fixed to an outer peripheral face on the opposite-to-output side of the rotation shaft 2 which is disposed in an inside of the stator 6. An outer peripheral face of the permanent magnet 3 is alternately magnetized with an “N”-pole and an “S”-pole along the circumferential direction. An end face 3a on the opposite-to-output side of the permanent magnet 3 is formed with a recessed part 3b which is recessed toward an output side in a ring shape so as to surround the rotation shaft 2. A detailed structure of the recessed part 3b will be described below. An end face on the output side of the permanent magnet 3 is formed with a recessed part 3c which is recessed toward the opposite-to-output side in a tube shape so as to surround the rotation shaft 2. The recessed part 3c functions as an adhesive reservoir which reserves an adhesive when the permanent magnet 3 is fixed to the rotation shaft 2.

The stator 6 includes a first stator assembly 14 and a second stator assembly 15 which are disposed so as to be superposed on each other in the axial direction. In this embodiment, the first stator assembly 14 is disposed on the opposite-to-output side and the second stator assembly 15 is disposed on the output side. The first stator assembly 14 includes an outer stator core 16, a bobbin 18 around which a drive coil 17 is wound, and an inner stator core 19 which sandwiches the bobbin 18 between the outer stator core 16 and the inner stator core 19. Similarly to the first stator assembly 14, the second stator assembly 15 includes an outer stator core 16, a bobbin 18 around which a drive coil 17 is wound, and an inner stator core 19.

The bobbin 18 is formed in a substantially cylindrical tube shape with flanges as a whole. A conducting wire is wound around an outer peripheral face of the bobbin 18 and the drive coil 17 is formed by winding the conducting wire around the outer peripheral face of the bobbin 18 in a substantially cylindrical tube shape. Further, a terminal block 18a is formed at the opposite-to-output side end of the bobbin 18 so as to protrude in the radial direction. Terminal pins 20 are fixed to the terminal block 18a and an end part of the conducting wire structuring the drive coil 17 is wound around and fixed to the terminal pin 20.

A plurality of pole teeth 5 which are formed in each of the outer stator core 16 and the inner stator core 19 is disposed on an inner peripheral side of the bobbin 18 so as to be adjacent to each other in the circumferential direction. The permanent magnet 3 is disposed on an inner peripheral side of the pole teeth 5. In other words, the drive coil 17 is disposed on an outer peripheral side of the permanent magnet 3. Further, an outer peripheral side of the drive coil 17 is covered by a part of the outer stator core 16. In other words, a part of the outer stator core 16 in this embodiment functions as a case body which covers the outer peripheral side of the drive coil 17.

The frame 7 is formed in a substantially rectangular groove shape and is structured of a bottom face part 7a, a side face part 7b which is stood up at a substantially right angle from an output side end of the bottom face part 7a, and a side face part 7c which is stood up at a substantially right angle from an opposite-to-output side end of the bottom face part 7a. The frame 7 is fixed to an end face on the output side of the stator 6. Specifically, the side face part 7c is fixed to the end face on the output side of the stator 6. The side face part 7c is formed with a through hole 7d in which a part of a lead screw 2a of the rotation shaft 2 is disposed.

The output side bearing 8 is formed of resin. Further, the bearing 8 is formed in a substantially bottomed cylindrical tube shape with a flange and the bearing 8 is formed with a bearing recessed part 8a which is recessed to the output side from an end face on the opposite-to-output side of the bearing 8. The bearing 8 is fixed to the side face part 7b so that its flange part 8b is abutted with a side face on the opposite-to-output side of the side face part 7b. The bearing 8 supports an end part on the output side of the rotation shaft 2 in an axial direction and a radial direction.

A bearing holder 21 which slidably holds the opposite-to-output side bearing 9 in the axial direction is fixed to an end face on the opposite-to-output side of the stator 6. A plate spring 22 as an urging member for urging the bearing 9 to the output side is fixed to the bearing holder 21. Next, detailed structure of the bearing 9, the bearing holder 21 and a recessed part 3b of the permanent magnet 3 will be described below.

(Structure of Bearing, Bearing Holder and Recessed Part of Permanent Magnet)

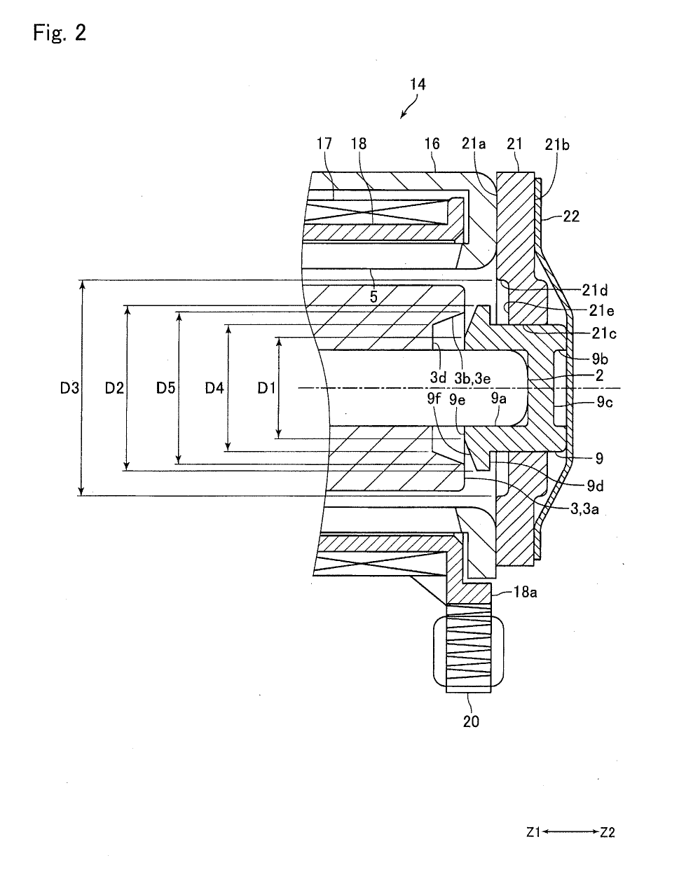

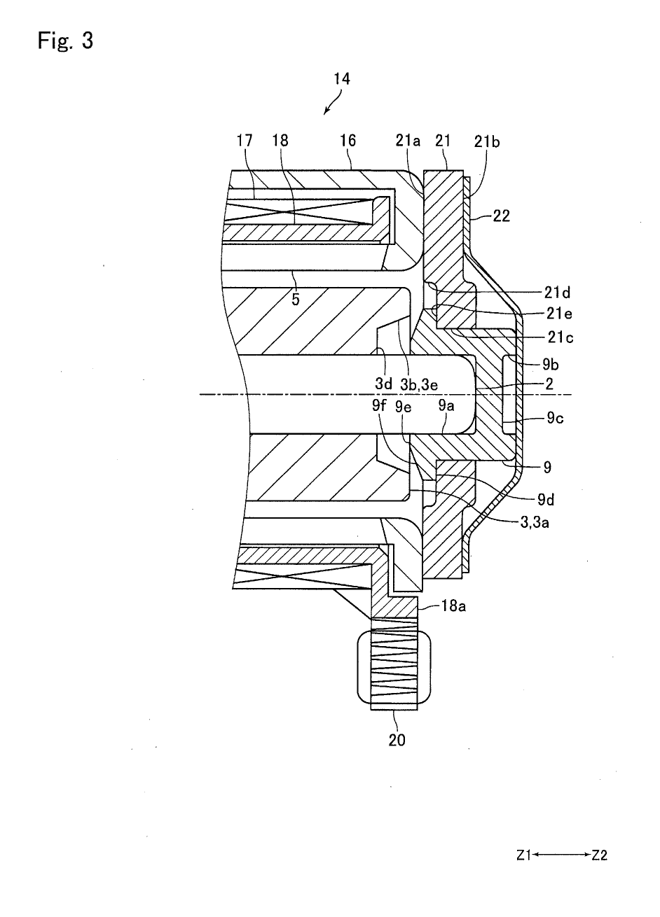

FIG. 2 is an enlarged view showing an “E” part in FIG. 1(A). FIG. 3 is an enlarged view showing an “F” part in FIG. 1(B).

The bearing holder 21 is formed in a substantially disk shape. Further, the bearing holder 21 is formed of metal. For example, the bearing holder 21 is formed of a stainless-steel plate. An end face (side face) 21a on the output side of the bearing holder 21 is fixed to the outer stator core 16 of the first stator assembly 14. In this embodiment, the end face 21a of the bearing holder 21 is fixed to the outer stator core 16 of the first stator assembly 14 by welding. The plate spring 22 is fixed to an end face (side face) 21b on the opposite-to-output side of the bearing holder 21. In this embodiment, the plate spring 22 is fixed to the end face 21b of the bearing holder 21 by welding.

A bearing holding hole 21c which slidably holds the bearing 9 in the axial direction is formed at a substantially center of the bearing holder 21 so as to penetrate through the bearing holder 21 in the axial direction. The end face 21a on the output side of the bearing holder 21 is formed with a recessed part 21d as a holder recessed part which is recessed toward the opposite-to-output side. The recessed part 21d is formed in a ring shape surrounding the bearing holding hole 21c. In this embodiment, the recessed part 21d is formed in the end face 21a by performing a half blanking work by a press at a center portion of a metal plate formed in a substantially disk shape. A bottom face 21e of the recessed part 21d is formed in a flat face which is perpendicular to the axial direction. In the recessed part 21d, the bottom face 21e structures the end face 21a on the output side of the bearing holder 21.

The opposite-to-output side bearing 9 is formed of resin. Further, the bearing 9 is formed in a substantially bottomed cylindrical tube shape with a flange. The bearing 9 is formed with a recessed part 9a as a bearing recessed part which is recessed toward the opposite-to-output side from an end face 9e on the output side of the bearing 9 and an opposite-to-output side end of the rotation shaft 2 is inserted into the recessed part 9a. Further, the bearing 9 is formed with a recessed part 9b which is recessed toward the output side from an end face on the opposite-to-output side of the bearing 9. A bottom part 9c of the bearing 9 is formed between the recessed part 9a and the recessed part 9b. A depth of the recessed part 9a (depth in the axial direction) into which the opposite-to-output side end of the rotation shaft 2 is inserted is larger than a depth of the recessed part 9b (depth in the axial direction). In this embodiment, the depth of the recessed part 9b is set so that a remaining trace of a gate part at the time of molding the bearing 9 does not protrude from the end face on the opposite-to-output side of the bearing 9.

The bearing 9 is urged to the output side by the plate spring 22 and the opposite-to-output side end of the rotation shaft 2 is abutted with an output side face of the bottom part 9c. The opposite-to-output side end of the rotation shaft 2 is supported by the output side face of the bottom part 9c in the axial direction. Further, a side face of the end part on the opposite-to-output side of the rotation shaft 2 is supported by a side face of the recessed part 9a in a radial direction. In other words, the end part on the opposite-to-output side of the rotation shaft 2 is disposed in the inside of the recessed part 9a and is supported by the bearing 9 in the radial direction and the axial direction.

A protruded part 9d protruding to an outer side in a radial direction is formed at an output side end of the bearing 9. The protruded part 9d is formed in a ring shape. In other words, the protruded part 9d is formed in a flange shape over the entire region in a circumferential direction and is formed as an abutting part with the bottom face 21e of the recessed part 21d, which is the end face 21a on the output side of the bearing holder 21, for preventing the bearing 9 from excessively sliding to the opposite-to-output side. Therefore, the protruded part 9d of the bearing 9 and the bottom face 21e of the recessed part 21d of the bearing holder 21 structure an excessive slide prevention mechanism which prevents the bearing 9 from excessively sliding to the opposite-to-output side. Further, an inclined face 9f which is inclined to an opposite-to-output side toward an outer side in the radial direction is formed on an outer peripheral side of an end face 9e on the output side of the bearing 9. An inner diameter “D1” of the inclined face 9f (see FIG. 2) is smaller than an outer diameter of a portion of the bearing 9 except the protruded part 9d. Further, the inclined face 9f is formed to an outer peripheral end of the protruded part 9d and an outer diameter “D2” of the inclined face 9f (see FIG. 2) is larger than the outer diameter of the portion of the bearing 9 except the protruded part 9d. Further, the outer diameter “D2” of the inclined face 9f is smaller than an outer diameter “D3” of the bottom face 21e of the recessed part 21d of the bearing holder 21 (see FIG. 2).

A bottom face 3d of a recessed part 3b of the permanent magnet 3 is formed to be a flat face which is perpendicular to the axial direction. A side face 3e of the recessed part 3b is formed to be an inclined face whose inner diameter gradually becomes larger toward the opposite-to-output side. The minimum inner diameter “D4” of the side face 3e (see FIG. 2) is larger than the inner diameter “D1” of the inclined face 9f. The maximum inner diameter “D5” of the side face 3e (see FIG. 2) is smaller than the outer diameter “D2” of the inclined face 9f. Further, an outer diameter of the permanent magnet 3 is larger than the outer diameter “D2” of the inclined face 9f and is smaller than the outer diameter “D3” of the bottom face 21e of the recessed part 21d of the bearing holder 21.

In this embodiment, the recessed part 9a of the bearing 9 is formed and the permanent magnet 3 is fixed to the rotation shaft 2 so that, when the opposite-to-output side end of the rotation shaft 2 is abutted with the output side face of the bottom part 9c, the end face 3a on the opposite-to-output side of the permanent magnet 3 and the end face 9e on the output side of the bearing 9 are disposed so as to form substantially the same plane. As described above, the minimum inner diameter “D4” of the side face 3e of the recessed part 3b is set to be larger than the inner diameter “D1” of the inclined face 9f and thus, even when the end face 3a on the opposite-to-output side of the permanent magnet 3 and the end face 9e on the output side of the bearing 9 are disposed so as to form substantially the same plane, the permanent magnet 3 and the bearing 9 are not contacted with each other.

Further, in this embodiment, the protruded part 9d is disposed on the output side with respect to the end face 21a on the output side of the bearing holder 21 and, in a normal operating state of the motor, a gap space is formed between the protruded part 9d and the end face 21a on the output side of the bearing holder 21 (bottom face 21e of the recessed part 21d). In other words, the protruded part 9d is disposed between the end face 3a on the opposite-to-output side of the permanent magnet 3 and the end face 21a on the output side of the bearing holder 21. Specifically, in a normal operating state of the motor 1 shown in FIG. 1(A) and FIG. 2, the protruded part 9d is disposed between a portion except the recessed part 21d of the end face 21a on the output side of the bearing holder 21 and the end face 3a on the opposite-to-output side of the permanent magnet 3. Therefore, when the fed body 11 which is moved to the output side of the rotation shaft 2 is collided with the bearing 8 as shown in FIG. 1(B) and the rotation shaft 2 is moved to the opposite-to-output side and, as shown in FIG. 3, when the bearing 9 is excessively slid to the opposite-to-output side together with the rotation shaft 2, the protruded part 9d of the bearing 9 is abutted with the end face 21a on the output side of the bearing holder 21 (specifically, the protruded part 9d is abutted with the bottom face 21e of the recessed part 21d). As a result, slide movement to the opposite-to-output side of the bearing 9 is prevented and the rotor 4 is not further moved to the opposite-to-output side.

(Principal Effects in this Embodiment)

As described above, in this embodiment, the protruded part 9d formed in the bearing 9 is disposed between the end face 3a on the opposite-to-output side of the permanent magnet 3 and the end face 21a on the output side of the bearing holder 21. Therefore, when the fed body 11 which is moved to the output side of the rotation shaft 2 is collided with the bearing 8 and the rotation shaft 2 is moved to the opposite-to-output side and, when the bearing 9 is excessively slid to the opposite-to-output side together with the rotation shaft 2, the protruded part 9d of the bearing 9 is abutted with the end face 21a on the output side of the bearing holder 21 (specifically, the bottom face 21e of the recessed part 21d) and the rotor 4 is not further moved to the opposite-to-output side. Accordingly, in this embodiment, the end face 3a on the opposite-to-output side of the permanent magnet 3 is prevented from being abutted with the end face 21a on the output side of the bearing holder 21 and, as a result, sticking of the permanent magnet 3 to the bearing holder 8 is prevented.

Further, in this embodiment, even when the fed body 11 which is moved to the output side of the rotation shaft 2 is collided with the bearing 8 and the rotation shaft 2 is moved to the opposite-to-output side and, when the bearing 9 is excessively slid to the opposite-to-output side together with the rotation shaft 2, only an end part on the opposite-to-output side of the rotation shaft 2 in the rotor 4 is abutted with the output side face of the bottom part 9c of the bearing 9 and other portions of the rotor 4 are not abutted with the bearing 9 and the bearing holder 21. In other words, even when the bearing 9 is excessively slid to the opposite-to-output side together with the rotation shaft 2, a frictional resistance of a fixed side member such as the bearing 9 and the bearing holder 21 with the rotor 4 is small. Therefore, in this embodiment, even when the bearing 9 is excessively slid to the opposite-to-output side together with the rotation shaft 2, the rotation shaft 2 can be easily rotated in a direction in which the fed body 11 is moved to the opposite-to-output side.

Especially, in this embodiment, the protruded part 9d is formed in a flange shape over the entire region in the circumferential direction and thus, the end face 3a on the opposite-to-output side of the permanent magnet 3 is effectively prevented from abutting with the end face 21a on the output side of the bearing holder 21.

In this embodiment, the recessed part 3b is formed on the end face 3a on the opposite-to-output side of the permanent magnet 3 and the inclined face 9f is formed on the end face 9e on the output side of the bearing 9. Therefore, in this embodiment, even when a distance between the end face 3a on the opposite-to-output side of the permanent magnet 3 and the end face 9e on the output side of the bearing 9 is set to be small, contacting of the permanent magnet 3 with the bearing 9 is prevented. As a result, the size of the motor 1 can be reduced in the axial direction. Further, in this embodiment, even in a case that the protruded part 9d is largely protruded to the outer side in the radial direction for stabilizing an abutting state of the protruded part 9d with the bearing holder 21 when the protruded part 9d is abutted with the end face 21a on the output side of the bearing holder 21, contacting of the permanent magnet 3 with the protruded part 9d is prevented.

In this embodiment, the recessed part 21d is formed in the end face 21a on the output side of the bearing holder 21. Therefore, in this embodiment, even when the protruded part 9d is formed in the bearing 9, the bearing 9 can be slid to the opposite-to-output side by a recessed amount of the recessed part 21d. Accordingly, in this embodiment, even when the protruded part 9d is formed in the bearing 9, a slide amount of the bearing 9 with respect to the bearing holder 21 can be secured. In other words, when a slide amount of the bearing 9 with respect to the bearing holder 21 is secured, it may be structured that the protruded part 9d of the bearing 9 is abutted with the end face 21a on the output side of the bearing holder 21 which is formed to be a flat face without forming the recessed part 21d.

### Other Embodiments

Although the present invention has been shown and described with reference to a specific embodiment, various changes and modifications will be apparent to those skilled in the art from the teachings herein.

In the embodiment described above, the protruded part 9d of the bearing 9 is formed in a ring shape so that an entire output side end in the circumferential direction of the bearing 9 is protruded to the outer side in the radial direction. However, the present invention is not limited to this embodiment. For example, the protruded part 9d may be formed so that a part in the circumferential direction of the output side end of the bearing 9 is protruded to the outer side in the radial direction. Further, in the embodiment described above, the protruded part 9d is formed at the output side end of the bearing 9 but the protruded part 9d may be formed at an intermediate position of the bearing 9 in the axial direction.

In the embodiment described above, when the opposite-to-output side end of the rotation shaft 2 is abutted with the output side face of the bottom part 9c, the end face 3a on the opposite-to-output side of the permanent magnet 3 and the end face 9e on the output side of the bearing 9 are disposed to form substantially the same plane. However, the present invention is not limited to this embodiment. For example, when the opposite-to-output side end of the rotation shaft 2 is abutted with the output side face of the bottom part 9c, the end face 9e may be disposed on the opposite-to-output side or may be disposed on the output side with respect to the end face 3a. In a case that the end face 9e is disposed on the opposite-to-output side with respect to the end face 3a, no inclined face 9f may be formed in the end face 9e. Further, in a case that the end face 9e is disposed on the opposite-to-output side with respect to the end face 3a, no recessed part 3b may be formed in the permanent magnet 3.

In the embodiment described above, the recessed part 21d is formed in the end face 21a on the output side of the bearing holder 21 but it may be structured that no recessed part 21d is formed in the end face 21a. In other words, the end face 21a may be formed to be a flat face. Further, in the embodiment described above, the bearing holder 21 is directly fixed to the outer stator core 16 of the first stator assembly 14. However, the bearing holder 21 may be fixed to the outer stator core 16 of the first stator assembly 14 through another structural member. Further, in the embodiment described above, the bearing holder 21 is formed of metal but the bearing holder 21 may be formed of resin. In this case, the plate spring 22 is fixed to the end face 21b on the opposite-to-output side of the bearing holder 21 by an adhesive. Further, in the embodiment described above, the plate spring 22 is fixed to the bearing holder 21 but the plate spring 22 may be fixed to the stator 6.

In the embodiment described above, the feed screw 2a is formed on a portion of the rotation shaft 2 which is protruded from the stator 6. However, the present invention is not limited to this embodiment. For example, a feed screw which is separately formed from the rotation shaft 2 may be fixed to an output side of the rotation shaft 2. Further, in the embodiment described above, the rotor 4 is provided with one permanent magnet 3. However, the rotor 4 may be provided with two or more permanent magnets 3. Further, in the embodiment described above, the stator 6 is structured of the first stator assembly 14 and the second stator assembly 15. However, the stator 6 may be structured of one stator assembly or may be structured of three or more stator assemblies. Further, in the embodiment described above, the motor 1 is a stepping motor. However, the motor to which the present invention is applied may be a motor other than a stepping motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotation shaft whose output side is formed or fixed with a feed screw;
a permanent magnet which is fixed to an outer peripheral face on an opposite-to-output side of the rotation shaft;
a stator having a drive coil which is disposed on an outer peripheral side in a radial direction of the rotation shaft with respect to the permanent magnet;
a bearing which supports an end part on the opposite-to-output side of the rotation shaft at least in an axial direction of the rotation shaft;
a bearing holder which is fixed to the opposite-to-output side of the stator and slidably holds the bearing in the axial direction; and
an urging member which urges the bearing to an output side;
wherein the bearing is formed with a protruded part which is protruded to an outer side in the radial direction of the rotation shaft; and
wherein the protruded part is disposed between an end face on the opposite-to-output side of the permanent magnet and an end face on the output side of the bearing holder.

2. The motor according to claim 1, wherein the protruded part is formed in a flange shape over an entire region in a circumferential direction of the rotation shaft.

3. The motor according to claim 1, wherein
the protruded part is formed at an output side end of the bearing, and
the end face on the opposite-to-output side of the permanent magnet is formed with a recessed part which is recessed toward the output side so as to surround the rotation shaft.

4. The motor according to claim 3, wherein an end face on the output side of the bearing is formed with an inclined face which is inclined to the opposite-to-output side toward an outer side in the radial direction.

5. The motor according to claim 4, wherein the end face on the opposite-to-output side of the permanent magnet and the end face on the output side of the bearing are disposed so as to form substantially the same plane.

6. The motor according to claim 4, wherein
a gap space is formed between the protruded part and the end face on the output side of the bearing holder in a normal operating state of the motor, and
when the bearing is excessively slid to the opposite-to-output side together with the rotation shaft, the protruded part of the bearing is abutted with the end face on the output side of the bearing holder to prevent slide of the bearing to the opposite-to-output side.

7. The motor according to claim 4, wherein
the bearing holder is formed with a bearing holding hole which slidably holds the bearing,
the end face on the output side of the bearing holder is formed with a holder recessed part which is recessed toward the opposite-to-output side, and
the holder recessed part is formed so as to surround the bearing holding hole.

8. The motor according to claim 1, wherein the bearing is formed with a bearing recessed part into which the end part on the opposite-to-output side of the rotation shaft is inserted so as to be recessed from an end face on the output side of the bearing toward the opposite-to-output side.

9. The motor according to claim 1, wherein
a gap space is formed between the protruded part and the end face on the output side of the bearing holder in a normal operating state of the motor, and
when the bearing is excessively slid to the opposite-to-output side together with the rotation shaft, the protruded part of the bearing is abutted with the end face on the output side of the bearing holder to prevent slide of the bearing to the opposite-to-output side.

10. The motor according to claim 9, wherein
the bearing is formed in a substantially bottomed cylindrical tube shape with a flange,
the bearing is formed with a recessed part as a bearing recessed part which is recessed toward the opposite-to-output side from an end face on the output side of the bearing,
an opposite-to-output side end of the rotation shaft is inserted into the recessed part, and
the protruded part is formed so as to protrude from the end face on the output side of the bearing to the outer side in the radial direction of the rotation shaft.

11. The motor according to claim 10, wherein the protruded part is formed in a flange shape over an entire region in a circumferential direction of the rotation shaft.

12. The motor according to claim 10, wherein the end face on the opposite-to-output side of the permanent magnet is formed with a recessed part which is recessed toward the output side and surrounds the rotation shaft so as to prevent contacting with an end face on the output side of the bearing.

13. The motor according to claim 12, wherein an end face on the output side of the protruded part is formed with an inclined face which is inclined to the opposite-to-output side toward an outer side in the radial direction.

14. The motor according to claim 13, wherein
the bearing holder is formed with a bearing holding hole which slidably holds the bearing,
the end face on the output side of the bearing holder is formed with a holder recessed part which is recessed toward the opposite-to-output side,
the holder recessed part is formed so as to surround the bearing holding hole, and
the protruded part of the bearing is capable of abutting with a bottom face of the holder recessed part.

15. The motor according to claim 9, wherein
the motor further comprises an output side bearing which rotatably supports an end part on the output side of the rotation shaft and a frame which is fixed with the output side bearing and is fixed to the stator,
the frame is structured of a bottom face part, a side face part on the output side which is stood up at a substantially right angle from an output side end of the bottom face part, and a side face part on the opposite-to-output side which is stood up at a substantially right angle from an opposite-to-output side end of the bottom face part, and
the side face part on the opposite-to-output side is fixed to an end face on the output side of the stator and the output side bearing is fixed to the side face part on the output side.
